(19) United States
(12) Patent Application Publication
(10) Pub. No.: US 2005/0237443 A1
(43) Pub. Date: Oct. 27, 2005

(54) Liquid crystal display device and manufacturing method of the same

(76) Inventors: Norio Nakanishi, Chiba (JP); Hideo Mitani, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/110,719

(22) Filed: Apr. 21, 2005

(30) Foreign Application Priority Data
Apr. 22, 2004 (JP) 2004-126183

(51) Int. Cl. G02F 1/1333

(52) U.S. Cl. 349/58

(57) ABSTRACT

There is provided a liquid crystal display device ensuring a luminance of a backlight and having a backlight-integrated type resin holder to which a plating has been adhered. A liquid crystal display device including a liquid crystal display panel, a backlight disposed to a back face of the liquid crystal display panel and having at least a light conductor, and a holder accommodating the liquid crystal display panel and the backlight, wherein the holder is a holder in which a 1st resin to which a plating can be applied and a 2nd white resin whose condition under which the plating adheres is different from the 1st resin have been molded in 2 colors, the plating is applied to the 1st resin, and the 2nd white resin to which no plating is applied is disposed to a side face of the light conductor. It is desirable that the 1st resin is a plastic alloy containing polycarbonate, and the 2nd resin is polycarbonate.

The present application claims priority from Japanese application JP2004-126183 filed on Apr. 22, 2004, the content of which is hereby incorporated by reference into this application.

### BACKGROUND OF THE INVENTION

The present invention concerns a liquid crystal display device and a manufacturing method of the same, and especially relates to a technique effective for being applied to a holder retaining a liquid crystal display panel.

In recent years, the small liquid crystal display panel (for example, liquid crystal display panel of a TFT (Thin Film Transistor) system, and the like) is widely used as a display part of a portable equipment such as portable telephone as shown, for example, in FIG. 4A and FIG. 4B.

Incidentally, FIG. 4A and FIG. 4B are drawings for explaining the portable telephone in which the liquid crystal display panel of the TFT system is used as the display part, wherein FIG. 4A is a front view, and FIG. 4B a side view.

In FIG. 4A and FIG. 4B, an LCD denotes the liquid crystal display panel. Generally, this liquid crystal display panel is supplied to an assembly process of the portable telephone under a state of such a liquid crystal display module as shown in FIG. 5.

FIG. 6 is an exploded, developed view showing a schematic constitution of the liquid crystal display module shown in FIG. 5.

As shown in FIG. 6, the liquid crystal display module shown in FIG. 5 is constituted with the liquid crystal display panel (LCD), a light conductor 10, a mold 11 and a reflecting sheet 12 being disposed in a frame (LCA) in order shown in FIG. 6.

Incidentally, 13 denotes a semiconductor chip for driving each sub-pixel in the liquid crystal display panel (LCD) Further, the light conductor 10 and the mold 11 constitute a backlight. Further, also upper and lower diffusion sheets and a lens sheet are disposed in an upper side of the light conductor 10, i.e., between the liquid crystal display panel (LCD) and the light conductor 10, but diagramatic representations of these optical sheets are omitted in FIG. 6. Similarly, the diagramatic representation of a light source is omitted as well.

For the frame (LCA) shown in FIG. 6, an electrical conductivity is demanded for an EMI countermeasure, and a strength is demanded. For this reason, an Mg die-cast component is used as the frame (LCA).

### SUMMARY OF THE INVENTION

As mentioned above, for the frame (LCA), the Mg die-cast component is used, but there is a problem that the Mg die-cast component is expensive and inferior in its mass productivity.

In order to solve this problem, it is possible to intend to reduce a cost of the liquid crystal display module by using a resin frame to which a plating has been applied. However, in order to intend to additionally reduce the cost, it is more desirable to use a backlight-integrated type resin holder in which the mold 11 and the frame (LCA), which are shown in FIG. 6, have been integrated.

However, in the backlight-integrated type resin holder, there has been a problem that it is impossible to apply a plating in order to ensure a reflection luminance at the mold disposed to a side face of the light conductor 10.

The invention is one made in order to solve the above problem of the prior art, and an advantage of the invention is the fact that it is possible to provide a liquid crystal display device ensuring a luminance of the backlight and having the backlight-integrated type resin holder to which the plating has been adhered, and a manufacturing method of the same.

The above and other advantages and novel characteristics of the invention are made clear by the description in the present specification and the appended drawings.

Among the inventions disclosed in the present application, if an outline of representative one is simply explaining, it is as follows.

In order to obtain the advantage mentioned above, the invention is a liquid crystal display device possessing a liquid crystal display panel, a backlight disposed to a back face of the liquid crystal display panel and having at least a light conductor, and a holder accommodating the liquid crystal display panel and the backlight, wherein the holder is constituted by a holder in which a 1st resin to which a plating can be applied and a 2nd white resin whose condition under which the plating adheres is different from the 1st resin have been molded in 2 colors, the plating is applied to the 1st resin, and the 2nd white resin to which no plating is applied is disposed to a side face of the light conductor.

Further, the invention is a method of manufacturing a liquid crystal display device possessing a liquid crystal display panel, a backlight disposed to a back face of the liquid crystal display panel and having at least a light conductor, and a holder accommodating the liquid crystal display panel and the backlight, comprising a holder molding process which molds in 2 colors a 1st resin to which a plating can be applied and a 2nd white resin whose condition under which the plating adheres is different from the 1st resin, and a plating process which, after the holder molding process, applies the plating only to the 1st resin between the 1st resin and the 2nd resin, and in that the 2nd white resin to which no plating is applied is disposed to a side face of the light conductor.

Here, it is desirable that the 1st resin is a plastic alloy containing polycarbonate, and the 2nd resin is polycarbonate.

If an effect obtained by representative one among the inventions disclosed in the present application is simply explained, it is as follows.

According to the invention, it becomes possible to provide the liquid crystal display device ensuring the luminance of the backlight and having the backlight-integrated type resin holder to which the plating has been adhered, and the manufacturing method of the same.

### BRIEF DESCRIPTION OF THE DRAWINGS

FIG. 1 is an exploded, developed view showing a constitution of a backlight side of a liquid crystal display module of an embodiment of the invention;

FIG. 2 is a perspective view showing a state that each component shown in FIG. 1 has been assembled;

FIG. 3 is an enlarged view showing one part of a backlight-integrated type resin holder of the embodiment of the invention while being enlarged;

FIG. 4A and FIG. 4B are views for explaining a portable telephone in which a liquid crystal display panel of a TFT system is used as a display part;

FIG. 5 is a perspective view showing a liquid crystal display module to which the liquid crystal display panel has been mounted; and

FIG. 6 is an exploded, developed view showing a schematic constitution of the liquid crystal display module shown in FIG. 5.

### DESCRIPTION OF THE PREFERRED EMBODIMENTS

Hereunder, an embodiment of the invention is explained by referring to the drawings.

Incidentally, in all drawings for explaining the embodiment, the same reference numeral is applied to one having the same function, and its repeated explanation is omitted.

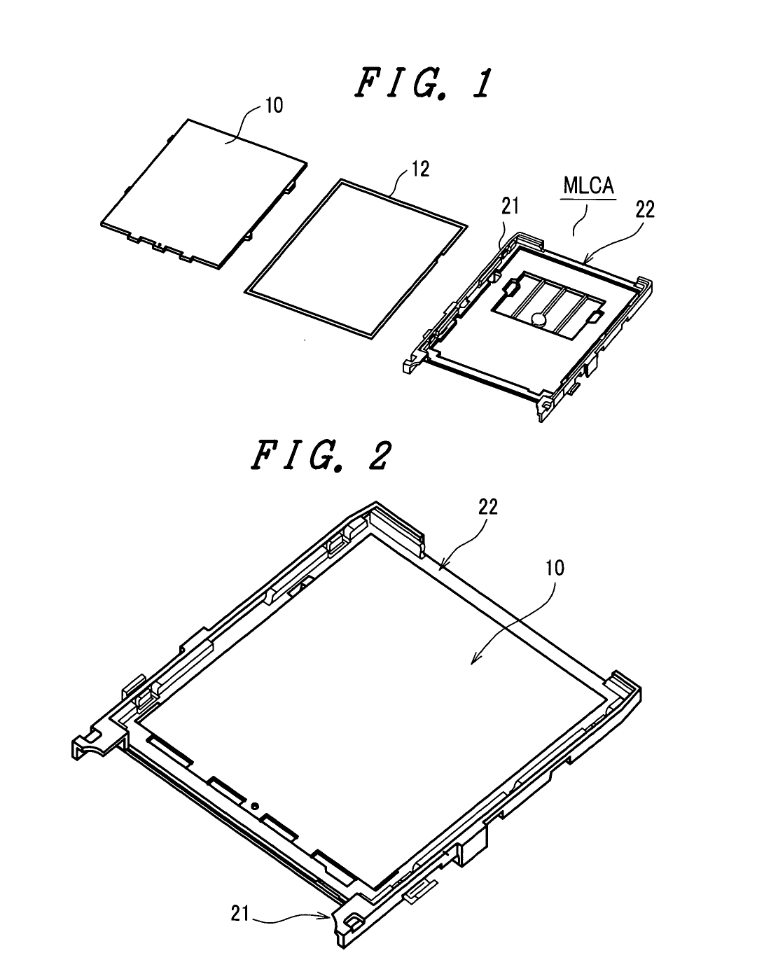

FIG. 1 is an exploded, developed view showing a constitution of a backlight side of a liquid crystal display module of an embodiment of the invention, and FIG. 2 is a perspective view showing a state that each component shown in FIG. 1 has been assembled.

In FIG. 1 and FIG. 2, 10 denotes the light conductor, 12 the reflecting sheet, and an MLCA a backlight-integrated type resin holder.

The light conductor 10 and the reflecting sheet 12 are disposed in the backlight-integrated type resin holder (MLCA) in order shown in FIG. 1, and become a state shown in FIG. 2. Under the state shown in FIG. 2, on its upper part there is disposed the liquid crystal display panel (LCD), and thereby the liquid crystal display module of the present embodiment is constituted.

Incidentally, although the liquid crystal display panel (LCD) of the present embodiment is formed by mutually bonding a glass substrate (TFT), in which a thin film transistor, a drain line, a gate line and the like have been formed, and a glass substrate (CF), in which an opposed electrode, a color filter and the like have been formed, through a seal agent, and sealing a liquid crystal between the glass substrate (TFT) and the glass substrate (CF), an explanation of a constitution of each substrate is omitted because constitutions of the glass substrate (TFT) and the glass substrate (CF) don't relate directly to the invention. Further, it can be applied also to a simple matrix system liquid crystal display panel, not limited to the TFT system liquid crystal display panel.

Further, in FIG. 1 and FIG. 2, also the upper and lower diffusion sheets and the lens sheet are disposed in the upper side of the light conductor 10, but the diagramatic representations of these optical sheets are omitted in FIG. 1 and FIG. 2. Similarly, the diagramatic representation of the light source is omitted as well.

Using the backlight-integrated type resin holder (MLCA) is the most important characteristic of the present embodiment, and this backlight-integrated type resin holder (MLCA) is a holder in which a 1st resin 21 to which a plating can be applied and a 2nd white resin 22 whose condition under which the plating adheres is different from the 1st resin have been molded in 2 colors.

Here, the 1st resin 21 is a plastic alloy containing polycarbonate (PC), (for example, PC/ABS (Acrylonitrile-Butadien-Styrene), or PC/ASA (Acrylonitrile-Styrene-Acrylate) etc.), and the plating is applied to this 1st resin 21.

Further, the 2nd resin 22 is white polycarbonate, and no plating is applied to this 2nd resin 22.

Incidentally, the plastic alloy is a mixture of plastics, in which a rubber is blended or copolymerized with a plastic inferior in impact resistance in order to improve the impact resistance and the like. The mutual blend of the plastics has been performed between the plastics comparatively good in compatibility, but recently there is developed also a plastic alloy in which engineering plastics inferior in compatibility have been mutually graft- or block-copolymerized by using a compatibilizing agent.

As main blends, there are HIPS/ABS, PPE/PS, PC/ABS, PPE/PA, PES/LCP, PA/EPT, PC/ASA, POM/elastomer, and the like.

In the present embodiment, after the backlight-integrated type resin holder (MLCA) has been made by the 2-color molding by using the 1st resin 21 and the 2nd resin 22, the plating for the EMI countermeasure or for improving a strength is applied only to the 1st resin 21.

In this plating process, by optimizing conditions when performing the plating, it becomes possible to apply the plating only to the 1st resin 21 without applying the plating to the 2nd resin 22 of the backlight-integrated type resin holder (MLCA).

Here, the 2nd resin 22 of the backlight-integrated type resin holder (MLCA) is disposed to a side face of the light conductor 10.

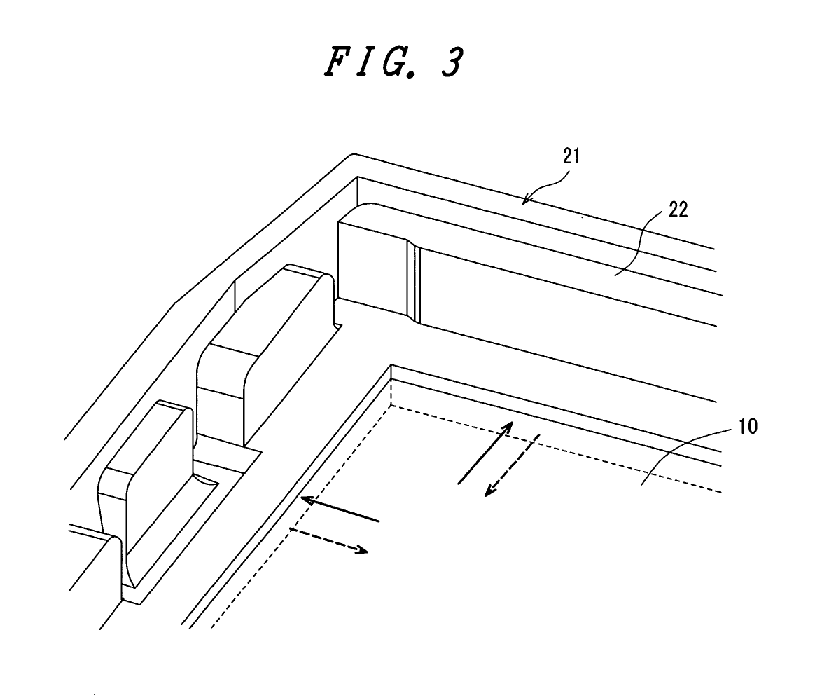

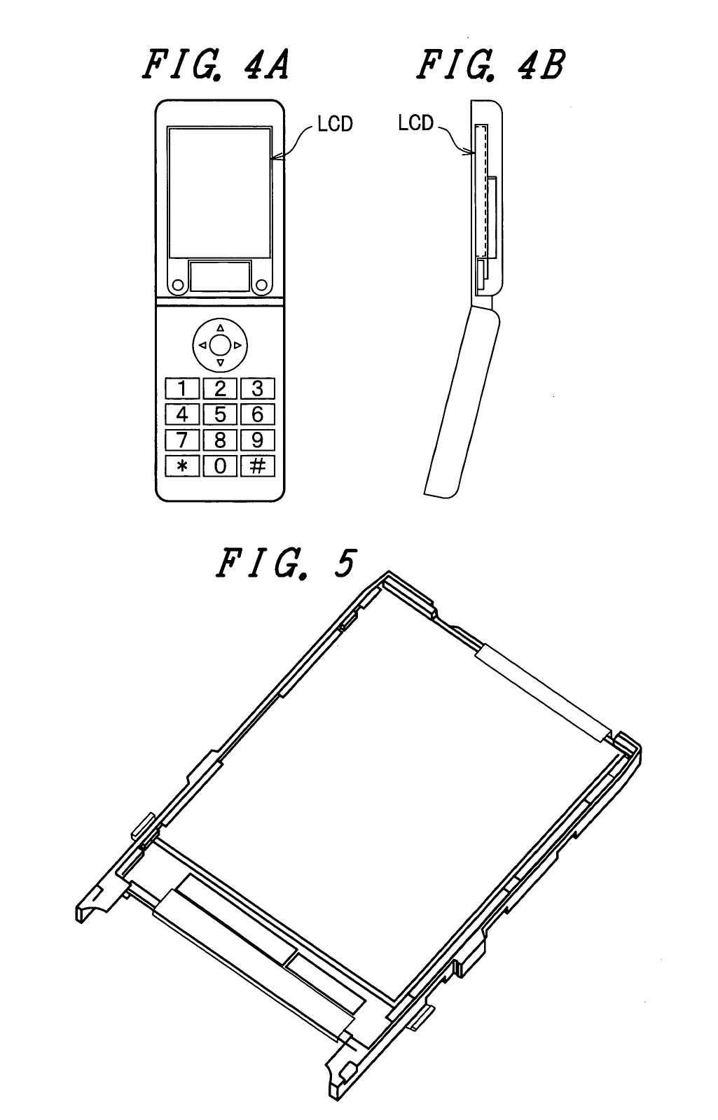

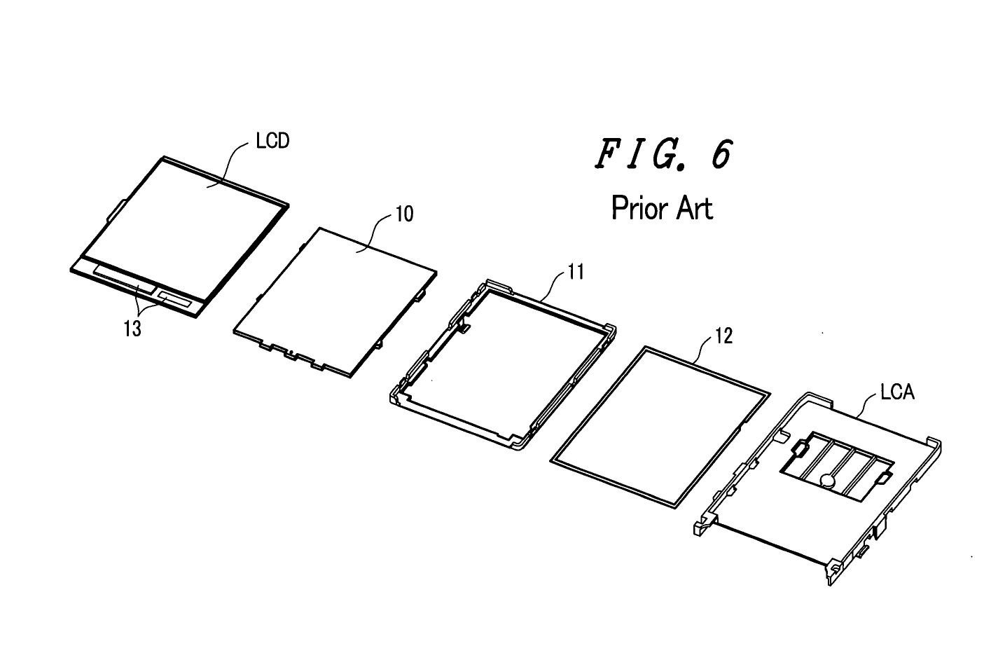

For this reason, as shown in FIG. 3, a light (light shown by a thick line in FIG. 3) having passed through the light conductor 10 is reflected by the 2nd resin 22 (polycarbonate) to which no plating is applied and whose surface is white, and the reflected light (light shown by thick broken line in FIG. 3) enters again into the light conductor 10, thereby entering into the liquid crystal display panel (LCD).

It seems that the plating may be applied to the 2nd resin 22 because, even if the plating is applied to the 2nd resin 22 disposed to the side face of the light conductor 10, the light having passed through the light conductor 10 is reflected by the plating of the 2nd resin 22 and enters again into the light conductor 10, but it is not linked with improvements in optical characteristics (reflectivity, reflection uniformity, and the like).

This is because in the case of the plating since the reflection at the side face of the light conductor 10 is an approximately specular reflection, a quantity of the light directed to a direction of the liquid crystal display panel (LCD) is small, but in the case of the white since it becomes a diffuse reflection, the quantity of the light directed to the direction of the liquid crystal display panel (LCD) increases, so that characteristics, such as luminance, of the whole backlight become good.

For this reason, like the present embodiment, it is necessary that no plating is applied to the 2nd resin 22 disposed to the side face of the light conductor 10, and the resin whose surface is white is used.

In the present embodiment, since the plating for the EMI countermeasure or for improving the strength is applied to the 1st resin 21 of the backlight-integrated type resin holder (MLCA), it is also possible to omit the reflecting sheet 12 and, in this case, it becomes possible to additionally reduce a product cost. However, in considering the optical characteristics (reflectivity, reflection uniformity, and the like), rather the reflecting sheet 12 is advantageous.

Further, in the present embodiment, it is possible to improve the strength of the 1st resin 21 by mixing carbon fibers and the like to the 1st resin 21.

Similarly, it is possible to improve the strength of the 2nd resin 22 by mixing glass fibers and the like also to the 2nd resin 22.

As explained above, in the present embodiment, since there is adapted so as to use the backlight-integrated type resin holder (MLCA) constituted by molding in 2 colors the 1st resin 21 to which the plating can be applied and the 2nd white resin 22 whose condition under which the plating adheres is different from the 1st resin, it becomes possible to decrease the number of components and reduce the product cost in comparison with conventional one.

In the above, although the invention made by the present inventor has been concretely explained on the basis of the above embodiment, it is needless to say that the invention is not limited to the above embodiment, and various modifications are possible within a scope not deviating from a gist of the invention.

1. A liquid crystal display device comprising:
a liquid crystal display panel,
a backlight disposed to a back face of the liquid crystal display panel and having at least a light conductor, and
a holder accommodating the liquid crystal display panel and the backlight,
wherein, the holder is a holder in which a 1st resin to which a plating can be applied and a 2nd white resin whose condition under which the plating adheres is different from the 1st resin have been molded in 2 colors,
the plating is applied to the 1st resin, and
the 2nd white resin to which no plating is applied is disposed to a side face of the light conductor.

2. A liquid crystal display device according to claim 1, wherein, the 1st resin is a plastic alloy containing polycarbonate, and the 2nd resin is polycarbonate.

3. A method of manufacturing a liquid crystal display device comprising:
a liquid crystal display panel,
a backlight disposed to a back face of the liquid crystal display panel and having at least a light conductor, and
a holder accommodating the liquid crystal display panel and the backlight,
comprising:
a holder molding process which molds in 2 colors a 1st resin to which a plating can be applied and a 2nd white resin whose condition under which the plating adheres is different from the 1st resin, and
a plating process which, after the holder molding process, applies the plating only to the 1st resin between the 1st resin and the 2nd resin,
wherein, the 2nd white resin to which no plating is applied is disposed to a side face of the light conductor.

4. A method of manufacturing a liquid crystal display device according to claim 3, wherein, the 1st resin is a plastic alloy containing polycarbonate, and the 2nd resin is polycarbonate.
